(19) United States
(12) Patent Application Publication
(10) Pub. No.: US 2026/0301652 A1
(43) Pub. Date: Oct. 1, 2026

(54) DISPLAY DEVICE, DISPLAY DEVICE LUMINANCE COMPENSATION METHOD AND ELECTRONIC DEVICE

(71) Applicant: Samsung Display Co., Ltd., Yongin-si (KR)

(72) Inventors: YOONSIK PARK, Yongin-si (KR); KYEONGSEOK LEE, Yongin-si (KR); JONG-WOON KIM, Yongin-si (KR)

(21) Appl. No.: 19/415,390

(22) Filed: Dec. 10, 2025

(30) Foreign Application Priority Data
Mar. 25, 2025 (KR) 10-2025-0038049

(51) Int. Cl. G09G 3/32

(52) U.S. Cl. CPC G09G 3/32; G09G 2320/0233; G09G 2320/0271; G09G 2320/0285; G09G 2330/021

(57) ABSTRACT

A display device includes a display panel including a plurality of pixels and configured to display an image and a driving controller configured to drive the display panel. The driving controller includes a memory in which a grayscale lookup table is stored, a frequency determination part configured to determine a driving frequency of the display panel, a luminance determination part configured to determine a target luminance and a target grayscale of the image, and a first luminance compensation part configured to output a first compensation luminance on the basis of the grayscale lookup table, the driving frequency, the target luminance, and the grayscale. The driving controller controls the display panel to display the image based on the first compensation luminance.

### CROSS-REFERENCE TO RELATED APPLICATION

The present application claims priority to and the benefit of Korean Patent Application No. 10-2025-0038049, filed on Mar. 25, 2025, the entire disclosure of which is incorporated herein by reference.

### BACKGROUND

Aspects of some embodiments of the present disclosure herein relate to a display device with relatively improved display quality, a display device luminance compensation method and an electronic device.

Various display devices used in multimedia apparatuses such as televisions, mobile phones, tablet computers, navigation units, and game consoles are being developed.

As fields in which such display devices are used become various, types of display layers for displaying images that are displayed on the display devices may vary as well.

Recently, a display layer may include an emissive display layer, and the emissive display layer may include an organic light-emitting display layer, a quantum dot light-emitting display layer, or the like.

The above information disclosed in this Background section is only for enhancement of understanding of the background and therefore the information discussed in this Background section does not necessarily constitute prior art.

### SUMMARY

Aspects of some embodiments of the present disclosure include a display device with relatively improved luminance variation, a display device luminance compensation method and an electronic device.

According to some embodiments of the present disclosure, a display device includes a display panel including a plurality of pixels and configured to display an image and a driving controller configured to drive the display panel, wherein the driving controller includes a memory part in which a grayscale lookup table is stored, a frequency determination part configured to determine a driving frequency of the display panel, a luminance determination part configured to determine a target luminance and a target grayscale of the image, and a first luminance compensation part configured to output a first compensation luminance on the basis of the grayscale lookup table, the driving frequency, the target luminance, and the grayscale, the driving controller controls the display panel to display the image on the basis of the first compensation luminance, the driving frequency includes a first driving frequency and a second driving frequency having a lower frequency than the first driving frequency, the first compensation luminance includes a first frequency compensation luminance output at the first driving frequency and a second frequency compensation luminance output at the second driving frequency, and the second frequency compensation luminance is higher than the first frequency compensation luminance.

According to some embodiments, in the grayscale lookup table, the first compensation luminance by grayscale, measured using multi-time programming (MTP), may be stored, the first frequency compensation luminance output at the first driving frequency and the second frequency compensation luminance output at the second driving frequency may be stored as the first compensation luminance, and a value obtained by adding a first offset to a luminance corresponding to a portion of grayscale of the first frequency compensation luminance may be stored as the second frequency compensation luminance.

According to some embodiments, a luminance ratio may be a value obtained by dividing a value obtained by subtracting a second luminance of the display panel driven at the first driving frequency from a first luminance of the display panel driven at the second driving frequency by the first luminance, and an absolute value of the luminance ratio may be equal to or lower than 6%.

According to some embodiments, the second frequency compensation luminance may be a value obtained by adding the first offset to the first frequency compensation luminance.

According to some embodiments, the driving controller may further include a temperature output part configured to output temperature of the display panel and a second luminance compensation part configured to add a second offset calculated on the basis of the temperature to the second frequency compensation luminance and output a second compensation luminance.

According to some embodiments, the second offset may be proportional to the temperature.

According to some embodiments, the second offset may have a constant value based on the temperature being equal to or higher than a predetermined first value.

According to some embodiments, the driving controller may further include a ratio output part configured to output an effective pixel ratio of the display panel and a third luminance compensation part configured to add a third offset calculated on the basis of the effective pixel ratio to the second compensation luminance and output a third compensation luminance.

According to some embodiments, the driving controller may control the display panel to display the image on the basis of the first compensation luminance, the second compensation luminance and the third compensation luminance.

According to some embodiments, the effective pixel ratio may be a ratio of turned-on pixels to the plurality of pixels, and the third offset may be proportional to the effective pixel ratio.

According to some embodiments, the third offset may have a constant value based on the effective pixel ratio being equal to or higher than a predetermined second value.

According to some embodiments of the present disclosure, in a display device luminance compensation method for compensating luminance of an display device comprising a display panel including a plurality of pixels and configured to display an image and a driving controller configured to drive the display panel and receive an image signal, the method includes generating a grayscale lookup table in which compensation luminance according to grayscale is stored by using multi-time programming (MTP), outputting a driving frequency of the display panel, outputting a target luminance and a target grayscale of the image on the basis of the image signal, outputting a first compensation luminance on the basis of the driving frequency, the target luminance, the target grayscale, and the grayscale lookup table, and displaying the image on the basis of the first compensation luminance, wherein the driving frequency includes a first driving frequency and a second driving frequency having a lower frequency than the first driving frequency, the first compensation luminance includes a first frequency compensation luminance output at the first driving frequency and a second frequency compensation luminance output at the second driving frequency, and the second frequency compensation luminance is higher than the first frequency compensation luminance.

According to some embodiments, a value obtained by adding a first offset to a luminance corresponding to a portion of grayscale may be stored in the grayscale lookup table at the second driving frequency compared to the grayscale lookup table at the first driving frequency.

According to some embodiments, a luminance ratio may be a value obtained by dividing a value obtained by subtracting a second luminance of the display panel driven at the first driving frequency from a first luminance of the display panel driven at the second driving frequency by the first luminance, and an absolute value of the luminance ratio may be equal to or lower than 6%.

According to some embodiments, the second frequency compensation luminance may be a value obtained by adding the first offset to the first frequency compensation luminance.

According to some embodiments, the display device luminance compensation method may include outputting a second compensation luminance which is obtained by adding a second offset calculated based on a temperature of the display panel to the second frequency compensation luminance.

According to some embodiments, the second offset may be proportional to the temperature, and the second offset may have a constant value based on the temperature being equal to or higher than a predetermined first value.

According to some embodiments, the display device luminance compensation method may further include outputting a third compensation luminance obtained by adding a third offset calculated based on an effective pixel ratio to the second compensation luminance.

According to some embodiments, the displaying of the image based on the first compensation luminance may include generating image data based on the second compensation luminance and the third compensation luminance.

According to some embodiments of the present disclosure, an electronic device includes a display panel including a plurality of pixels and configured to display an image, a driving controller configured to drive the display panel, and a processor configured to drive the driving controller, wherein the driving controller includes a memory part in which a grayscale lookup table is stored, a frequency determination part configured to determine a driving frequency of the display panel, a luminance determination part configured to determine a target luminance and a target grayscale of the image, and a first luminance compensation part configured to output a first compensation luminance based on the grayscale lookup table, the driving frequency, the target luminance, and the grayscale, the driving controller controls the display panel to display the image based on the first compensation luminance, the driving frequency includes a first driving frequency and a second driving frequency having a lower frequency than the first driving frequency, the first compensation luminance includes a first frequency compensation luminance output at the first driving frequency and a second frequency compensation luminance output at the second driving frequency, and the second frequency compensation luminance is higher than the first frequency compensation luminance.

### BRIEF DESCRIPTION OF THE DRAWINGS

The accompanying drawings are included to provide a further understanding of aspects of some embodiments according to the present disclosure, and are incorporated in and constitute a part of this specification. The drawings illustrate aspects of some embodiments of the present disclosure and, together with the description, serve to explain aspects of some embodiments of the present disclosure. In the drawings:

FIG. 1 is a block diagram of an electronic device according to some embodiments;

FIG. 2 is a schematic view of electronic devices according to some embodiments;

FIG. 3 is a block diagram of a display device according to some embodiments of the present disclosure;

FIG. 4 illustrates driving frequencies according to a driving operation of an electronic device according to some embodiments of the present disclosure;

FIG. 5 is a block diagram illustrating a driving controller according to some embodiments of the present disclosure;

FIG. 6 is a flowchart showing aspects of a method for driving an electronic device according to some embodiments of the present disclosure;

FIG. 7 is a graph showing a correlation between time, luminance and luminance ratio according to some embodiments of the present disclosure;

FIG. 8 is a graph showing luminance ratio for each display panel according to some embodiments of the present disclosure;

FIG. 9 is a block diagram illustrating a driving controller according to some embodiments of the present disclosure;

FIG. 10 is a graph showing second offset versus temperature according to some embodiments of the present disclosure;

FIG. 11 is a graph showing third offset versus effective pixel ratio according to some embodiments of the present disclosure; and

FIG. 12 is a graph showing a correlation between time, luminance and luminance ratio according to some embodiments of the present disclosure.

### DETAILED DESCRIPTION

In this specification, it will be understood that when an element (or a region, a layer, a portion, or the like) is referred to as being “on”, “connected to” or “coupled to” another element, it may be directly located on, connected to, or coupled to the other element, or other elements may be located therebetween.

Like reference numerals or symbols refer to like elements throughout. In the drawings, the thickness, ratio, and size of the elements are exaggerated for effectively describing the technical contents. As used herein, the term “and/or” includes any and all combinations of one or more of the associated listed elements.

It will be understood that, although the terms “first”, “second”, etc. may be used herein to describe various elements, the elements are not to be limited by these terms. These terms are only used to distinguish one element, component, region, layer or section from another element, component, region, layer or section. For instance, a first element, component, region, layer or section discussed below could be termed a second element, component, region, layer or section without departing from the scope of embodiments according to the present disclosure. Similarly, a second element, component, region, layer or section could be termed a first element, component, region, layer or section. In this specification, the singular expressions “a”, “an” and “the” are intended to include the plural forms as well, unless the context clearly indicates otherwise.

In addition, the terms “below”, “under”, “on the lower side”, “above”, “over”, “on the upper side”, or the like may be used to describe the relationships between the elements illustrated in the drawings. These terms are relative concepts and are described on the basis of the directions indicated in the drawings.

It will be further understood that the terms “comprises, includes, has” and/or “comprising, including, having”, when used in this specification, specify the presence of stated features, numbers, steps, operations, elements, components or combinations thereof, but do not preclude the possibility of the presence or addition of one or more other features, numbers, steps, operations, elements, components, and/or combinations thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, aspects of some embodiments of the present disclosure are described in more detail with reference to the drawings.

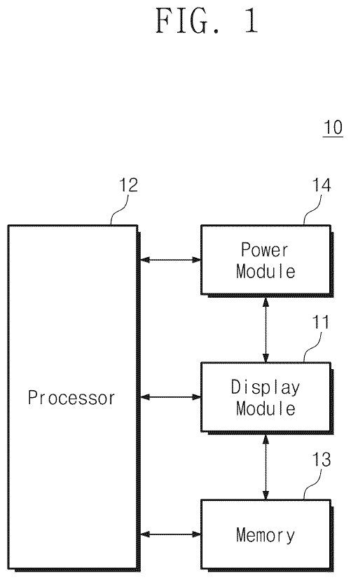

FIG. 1 is a block diagram of an electronic device according to some embodiments. Referring to FIG. 1, an electronic device 10 according to some embodiments may include a display module 11, a processor 12, a memory 13 and a power module 14.

The processor 12 may include at least one of a central processing unit (CPU), an application processor (AP), a graphic processing unit (GPU), a communication processor (CP), an image signal processor (ISP), or a controller.

Data information required for an operation of the processor 12 or the display module 11 may be stored in the memory 13. When the processor 12 executes an application stored in the memory 13, an image data signal and/or an input control signal may be transferred to the display module 11, and the display module 11 may process the provided signal and output image information through a display screen.

The power module 14 may include a power supply module such as a power adaptor or a battery device and a power conversion module which converts power supplied by the power supply module and generates power required for an operation of the electronic device 10.

At least one of the components of the electronic device 10 described above may be included in a display device according to some embodiments of the present disclosure. In addition, some of individual modules included in functionally one module may be included in the display device, and the other thereof may be provided separately from the display device. For example, the display device may include the display module 11, and the processor 12, the memory 13 and the power module 14 may be provided in a form of another device in the electronic device 10, not the display device.

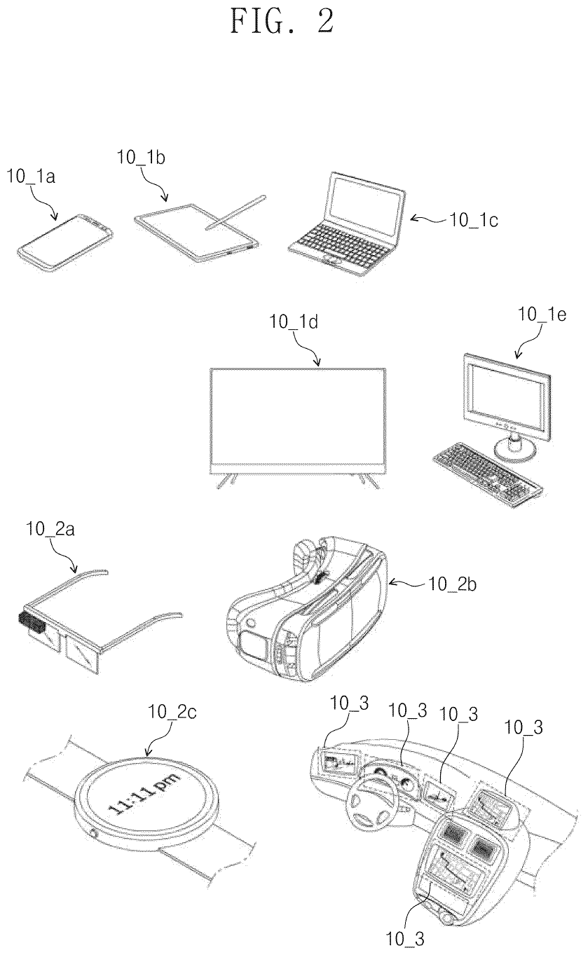

FIG. 2 is a schematic view of electronic devices according to some embodiments.

Referring to FIG. 2, various electronic devices to which a display device according to some embodiments is applied may include not only an electronic device for displaying images, such as a smartphone 10_1a, a tablet PC 10_1b, a laptop computer 10_1c, a television 10_1d and a desk monitor 10_1e, but also a wearable electronic device including a display module, such as smart glasses 10_2a, a head-mounted display 10_2b and a smart watch 10_2c, automotive electronic devices 10_3 including a display module, such as a center information display (CID) located on an instrumental panel, center fascia, and a dashboard of an automobile and a room mirror display, and the like.

Hereinafter, a display device according to some embodiments of the present disclosure and an electronic device including the display device are described with reference to the drawings.

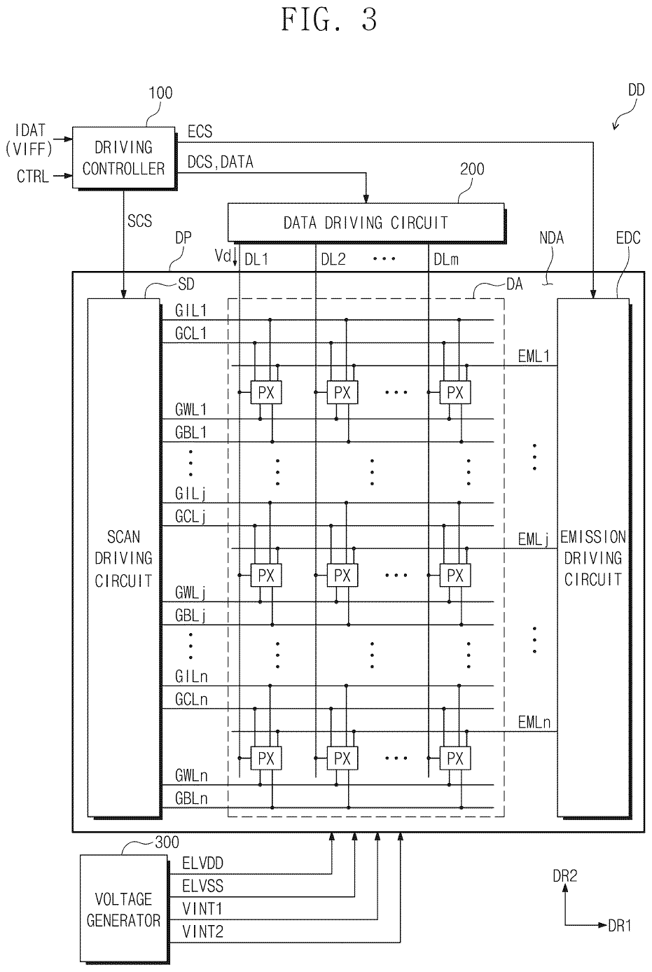

FIG. 3 is a block diagram of a display device according to some embodiments of the present disclosure.

Referring to FIG. 3, the electronic device 10 (see FIG. 1) may include a display device DD.

The display device DD may be activated in response to an electrical signal and display an image IM. The display device DD may include various embodiments. For example, the display device DD may include medium- and small-sized devices such as a monitor, a mobile phone, a tablet computer, a navigation unit and a game console as well as large-sized devices such as a television and an outdoor billboard. embodiments of the display device DD are examples, and are not limited to any one without departing from the spirit and scope of embodiments according to the present disclosure.

The display device DD according to some embodiments includes a display panel DP, a driving controller 100, a data driving circuit 200, and a voltage generator 300.

The driving controller 100 may be provided with an image signal IDAT and a control signal CTRL from an external host processor (for example, an application processor (AP), a graphic processing unit (GPU) or a graphic card). The processor 12 (see FIG. 1) may include a host processor. According to some embodiments, the image signal IDAT may be RGB image data including red image data, green image data and blue image data. In addition, according to some embodiments, the control signal CTRL may include a vertical synchronization signal, a horizontal synchronization signal, an input data enable signal, a master clock signal, etc., but embodiments according to the present disclosure are not limited thereto.

The host processor may provide the image signal IDAT including information about a driving frequency VIFF (or a variable frame rate) to the driving controller 100, and the driving controller 100 according to some embodiments of the present disclosure may receive input image data including the driving frequency VIFF from the host processor. According to some embodiments, the driving frequency VIFF may be changed to 120 hertz (Hz) to 60 Hz (or about 120 Hz or about 60 Hz), but embodiments according to the present disclosure are not limited thereto. The driving controller 100 may control the data driving circuit 200, a scan driving circuit SD and an emission driving circuit EDC so that the display panel DP is driven at the driving frequency VIFF. According to some embodiments, a mode, in which the display panel DP is driven at the driving frequency VIFF, of the display device DD may be referred to as a variable frame mode. For example, the variable frame mode may be a Free-Sync mode, a G-Sync mode, a Q-Sync mode, etc., but is not limited thereto.

The driving controller 100 may drive the display panel DP. The driving controller 100 receives the image signal IDAT and the control signal CTRL. The driving controller 100 generates an image data signal DATA by converting data format of the image signal IDAT to comply with specifications of interface with the data driving circuit 200. The driving controller 100 outputs a scan control signal SCS, a data control signal DCS and an emission driving signal ECS.

The data driving circuit 200 receives the data control signal DCS and the image data signal DATA from the driving controller 100. The data driving circuit 200 converts the image data signal DATA into data signals Vd and outputs the data signals Vd to a plurality of data lines DL1 to DLm to be described in more detail later. The data signals Vd are analog voltages corresponding to a grayscale value of the image data signal DATA.

The voltage generator 300 generates voltages required for an operation of the display panel DP. According to some embodiments, the voltage generator 300 generates a first driving voltage ELVDD, a second driving voltage ELVSS, a first initialization voltage VINT1 and a second initialization voltage VINT2.

The display panel DP according to some embodiments of the present disclosure may be an emissive display panel and is not particularly limited. For example, the display panel DP may be an organic light-emitting display panel, an inorganic light-emitting display panel, a micro-LED display panel or a nano-LED display panel. An emission layer of the organic light-emitting display panel may include an organic light-emitting material. An emission layer of the inorganic light-emitting display panel may include quantum dots, quantum rods, and the like. An emission layer of the micro-LED display panel may include a micro-LED. An emission layer of the nano-LED display panel may include a nano-LED.

The display panel DP includes scan lines GIL1 to GILn, GCL1 to GCLn, GWL1 to GWLn and GBL1 to GBLn, emission control lines EML1 to EMLn, data lines DL1 to DLm and pixels PX. The display panel DP may further include the scan driving circuit SD and the emission driving circuit EDC. The display panel DP may display an image.

The display panel DP may be divided into a display region DA and a non-display region NDA surrounding the display region DA. The pixels PX may be located in the display region DA. The scan driving circuit SD and the emission driving circuit EDC may be located in the non-display region NDA.

The plurality of pixels PX may each include a pixel driving circuit and a light-emitting element connected to the pixel driving circuit. The pixel driving circuit may include transistors including low-temperature polycrystalline silicon (LTPS).

According to some embodiments, the scan driving circuit SD is arranged on a first side of the display panel DP. The scan lines GIL1 to GILn, GCL1 to GCLn, GWL1 to GWLn and GBL1 to GBLn extend from the scan driving circuit SD in a first direction DR1.

The emission driving circuit EDC is arranged on a second side of the display panel DP. The emission control lines EML1 to EMLn extend from the emission driving circuit EDC in an opposite direction of the first direction DR1. The emission driving circuit EDC receives the emission driving signal ECS from the driving controller 100 and outputs emission control signals to the emission control lines EML1 to EMLn.

The scan lines GIL1 to GILn, GCL1 to GCLn, GWL1 to GWLn and GBL1 to GBLn and the emission control lines EML1 to EMLn are arranged spaced apart from each other in a second direction DR2. The data lines DL1 to DLm extend from the data driving circuit 200 in an opposite direction of the second direction DR2 and are arranged spaced apart from each other in the first direction DR1.

The plurality of pixels PX are electrically connected to the scan lines GIL1 to GILn, GCL1 to GCLn, GWL1 to GWLn and GBL1 to GBLn, the emission control lines EML1 to EMLn and the data lines DL1 to DLm. Each of the plurality of pixels PX may be electrically connected to four scan lines and one emission control line. For example, as illustrated in FIG. 3, pixels of a first row may be connected to the scan lines GIL1, GCL1, GWL1 and GBL1 and the emission control line EML1. In addition, pixels of a j-th row may be connected to the scan lines GILj, GCLj, GWLj and GBLj and the emission control line EMLj.

Each of the plurality of pixels PX receives the first driving voltage ELVDD, the second driving voltage ELVSS, the first initialization voltage VINT1 and the second initialization voltage VINT2 from the voltage generator 300.

The scan driving circuit SD receives the scan control signal SCS from the driving controller 100. The scan driving circuit SD may output scan signals to the scan lines GIL1 to GILn, GCL1 to GCLn, GWL1 to GWLn and GBL1 to GBLn in response to the scan control signal SCS.

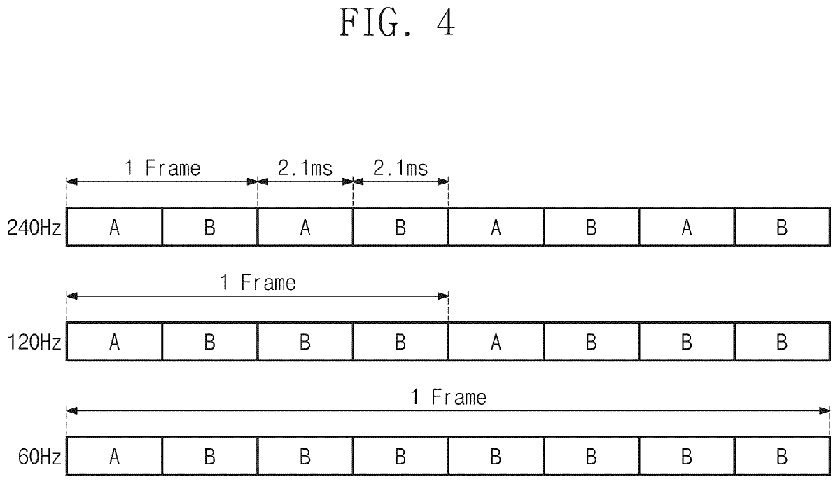

FIG. 4 illustrates driving frequencies according to a driving operation of an electronic device according to some embodiments of the present disclosure.

Referring to FIGS. 3 and 4, the display device DD may operate in a driving period A and a scan period B. The display device DD may control the driving frequency VIFF of the display panel DP through repeating the scan period B. The display device DD may synchronize frame generation of a host processor included in the display device DD and timing of frame output of the display panel DP. That is, the display panel DP may operate at a variable frequency. In this case, the display panel DP may be referred to as operating in a variable frequency mode. For example, when an operating frequency of the display device DD is lowered in specific operating environment such as displaying a static image, power consumption of the display device DD may be reduced.

The driving period A may be a period in which the plurality of pixels PX receive the data signal Vd and emit light, and the scan period B may be a period in which the plurality of pixels PX emit light without receiving the data signal Vd.

Each of the driving period A and the scan period B may be a period having a time of 2.1 (or about 2.1) milliseconds (ms). That is, each of the driving period A and the scan period B may have a frequency of 480 (or about) 480 hertz (Hz). However, this is an example, and a time of each of the driving period A and the scan period B according to some embodiments of the present disclosure is not limited thereto. For example, each of the driving period A and the scan period B may be a period having a time of 4.2 (or about 4.2) milliseconds (ms).

When a graphic processing unit generates a frame having a refresh rate of 240 Hz (or about 240 Hz), a scan driving circuit SD may control each of a period A and a period B to be driven once in one frame so that the display panel DP operates at a frequency of 240 (or about 240) Hz.

When the graphic processing unit generates a frame having a refresh rate of 120 (or about 120) Hz, the scan driving circuit SD may control the driving period A to be driven once and the scan period B to be driven three times in one frame so that the display panel DP operates at a frequency of 120 (or about 120) Hz.

When the graphic processing unit generates a frame having a refresh rate of 60 (or about 60) Hz, the scan driving circuit SD may control the driving period A to be driven once and the scan period B to be driven seven times in one frame so that the display panel DP operates at a frequency of 60 (or about 60) Hz. However, this is an example, and the scan driving circuit SD may control ratio of the driving period A and the scan period B and allow the display panel DP to operate at various frequencies.

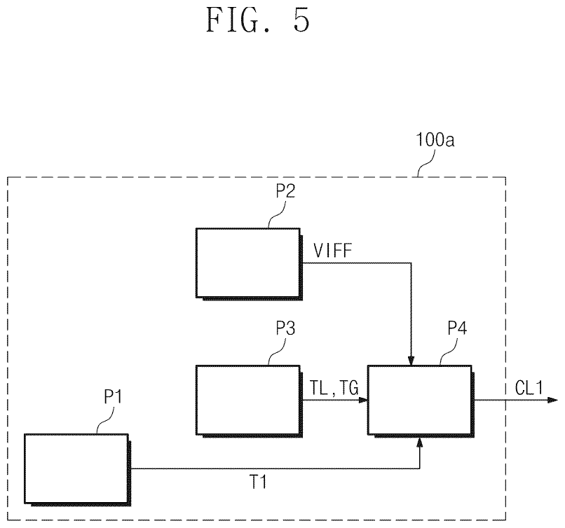

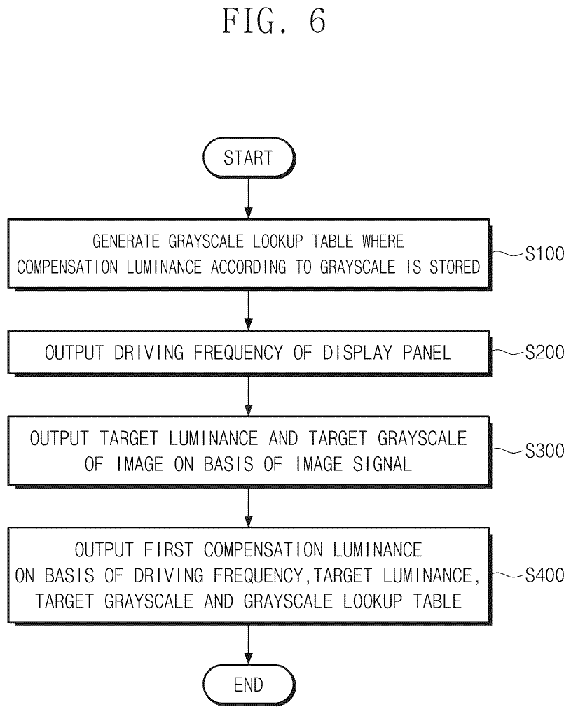

FIG. 5 is a block diagram illustrating aspects of a driving controller according to some embodiments of the present disclosure, and FIG. 6 is a flowchart showing aspects of a method for driving an electronic device according to some embodiments of the present disclosure. Although FIG. 6 illustrates various operations in a method for driving an electronic device, embodiments according to the present disclosure are not limited thereto, and according to various embodiments, the method may include additional operations, or fewer operations, unless otherwise stated or implied, without departing from the spirit and scope of embodiments according to the present disclosure.

Referring to FIGS. 1, 3, 5 and 6, the electronic device 10 may include the display panel DP which includes the plurality of pixels PX and displays an image, and the driving controller 100 which drives the display panel DP. The driving controller 100 may include a memory part (or memory or memory circuit or memory component) P1, a frequency determination part (or frequency determiner or frequency determination circuit or frequency determination component) P2, a luminance determination part (or luminance determiner or luminance determination circuit or luminance determination component) P3 and a first luminance compensation part (or first luminance compensator or first luminance compensation circuit or first luminance compensation component) P4. For example, the memory part P1, the frequency determination part P2, the luminance determination part P3 and the first luminance compensation part P4 may be referred to as a first driving part 100a.

A grayscale lookup table T1 generated from the outside may be stored in the memory part P1 (S100). Compensation luminance by grayscale of the display panel DP, measured using multi-time programming (MTP), is stored in the grayscale lookup table T1. The multi-time programming may refer to an operation of repeatedly correcting reference offset.

TABLE 1

| | Comparative lookup | | Grayscale lookup | |
|---|---|---|---|---|
| 20 nit(TL) | table | | table(T1) | |
| GRAY(TG) | 120 Hz(F1) | 60 Hz(F2) | 120 Hz(F1) | 60 Hz(F2) |
| 255 | 20 | 20 | 20 | 20 |
| 48 | 0.5074 | 0.5074 | 0.5074 | 0.5074 |
| 32 | 0.2080 | 0.2080 | 0.2080 | 0.2080 + R1 |
| | (FL1) | (FL2) | (FCL1) | (FCL2) |
| 24 | 0.1104 | 0.1104 | 0.1104 | 0.1104 + R1 |

Table 1 above is a comparative lookup table according to a comparative example of the present disclosure and the grayscale lookup table T1 according to some embodiments of the present disclosure.

In Table 1 above, 20 nit may refer to a target luminance TL. The target luminance TL is a luminance of the display panel DP when the data signal Vd provided to the plurality of pixels PX corresponds to a maximum grayscale. For example, when the target luminance TL is 20, a luminance of the display panel DP at a grayscale level of 255 may be 20 nit.

In Table 1 above, GRAY may refer to a target grayscale TG. The target grayscale TG may be defined as brightness of the image signal IDAT. The target grayscale TG may be defined gradually from 0 to 255. For example, Table 1 above shows the target grayscale TG having values of 255, 48, 32 and 24. For example, 255 and 48 may be referred to as high grayscale, and 32 and 24 may be referred to as low grayscale.

In Table 1 above, 120 Hz and 60 Hz may refer to the driving frequency VIFF. The driving frequency VIFF may include a first driving frequency F1 and a second driving frequency F2 different from the first driving frequency F1. For example, the first driving frequency F1 may be 120 Hz, and the second driving frequency F2 may be 60 Hz having a lower frequency than the first driving frequency F1. The first driving frequency F1 may be referred to as a high frequency, and the second driving frequency F2 may be referred to as a low frequency.

In the comparative lookup table in Table 1 above, a luminance of the first driving frequency F1 and a luminance of the second driving frequency F2 may be the same as each other at the same target grayscale TG. That is, a first frequency luminance FL1 and a second frequency luminance FL2 may be the same as each other.

In Table 1 above, the lookup table T1 may store a first compensation luminance CL1 according to the target luminance TL and the target grayscale TG.

The first compensation luminance CL1 may include a first frequency compensation luminance FCL1 output at the first driving frequency F1 and a second frequency compensation luminance FCL2 output at the second driving frequency F2.

The first frequency compensation luminance FCL1 and the second frequency compensation luminance FCL2 may be the same at the high grayscale, and the first frequency compensation luminance FCL1 and the second frequency compensation luminance FCL2 may be different from each other at the low grayscale. The second frequency compensation luminance FCL2 may be higher than the first frequency compensation luminance FCL1 due to a first offset R1 at the low grayscale.

When the display device DD operates in the variable frequency mode, the first offset R1 may be applied at the low grayscale of the low frequency to relatively improve luminance variation of the display panel DP between the high frequency and the low frequency. The first frequency compensation luminance FCL1 and the first frequency luminance FL1 corresponding to the high frequency may be the same (or substantially the same). The second frequency compensation luminance FCL2 and the second frequency luminance FL2 corresponding to the low frequency may be different.

When the target luminance TL is 20 nit and the target grayscale TG is 32, a value obtained by adding the first offset R1 to the first frequency compensation luminance FCL1 at 120 Hz may be stored as the second frequency compensation luminance FCL2 at 60 Hz in the grayscale lookup table T1. For example, when the target luminance TL is 20 nit and the target grayscale TG is 32, the second frequency compensation luminance FCL2 at 60 Hz in the grayscale lookup table T1 may be 0.2080+ (or about 0.2080+) the first offset R1, and the first frequency compensation luminance FCL1 at 120 Hz may be 0.2080 (or about 0.2080). In this case, the first compensation luminance CL1 at 120 Hz may be referred to as the first frequency compensation luminance FCL1, and the first compensation luminance CL1 at 60 Hz may be referred to as the second frequency compensation luminance FCL2. That is, the second frequency compensation luminance FCL2 may be higher than the first frequency compensation luminance FCL1.

However, this is an example, and a value obtained by adding the first offset R1 to the first frequency compensation luminance FCL1 at 120 Hz may be stored as the second frequency compensation luminance FCL2 at 60 Hz in the grayscale lookup table T1 corresponding to a portion of grayscale. The portion of grayscale may be low grayscale, and a luminance corresponding to the portion of grayscale may be a low luminance region.

In addition, when the target luminance TL is 20 nit and the target grayscale TG is 48, the second frequency compensation luminance FCL2 at 60 Hz in the grayscale lookup table T1 may be the same as the first frequency compensation luminance FCL1 at 120 Hz. For example, when the target luminance TL is 20 nit and the target grayscale TG is 48, the second frequency compensation luminance FCL2 at 60 Hz in the grayscale lookup table T1 may be 0.5074 (or about 0.5074), and the first frequency compensation luminance FCL1 at 120 Hz may be 0.5074 (or about 0.5074). That is, the first frequency compensation luminance FCL1 and the second frequency compensation luminance FCL2 may be the same at the high grayscale.

The frequency determination part P2 may output the driving frequency VIFF of the display panel DP. (S200)

The luminance determination part P3 may determine the target luminance TL and the target grayscale TG of an image on the basis of the image signal IDAT. (S300)

The first luminance compensation part P4 may output the first compensation luminance CL1 on the basis of the grayscale lookup table T1, the driving frequency, the target luminance TL and the target grayscale TG. (S400)

The display panel DP may display an image on the basis of the first compensation luminance CL1. The driving controller 100 may control the display panel DP to display an image on the basis of the first compensation luminance CL1. The image data signal DATA may be output in consideration of the first compensation luminance CL1, and the plurality of pixels PX may output an image on the basis of the image data signal DATA. Thus, the electronic device 10 with relatively improved display quality may be provided.

According to some embodiments of the present disclosure, the driving controller 100 may correct variation in the amount of luminance by using the grayscale lookup table T1. When the display device DD operates in the variable frequency mode, luminance variation of the display panel DP may be relatively improved. Thus, the electronic device 10 (see FIG. 1) with relatively improved display quality and a luminance compensation method may be provided.

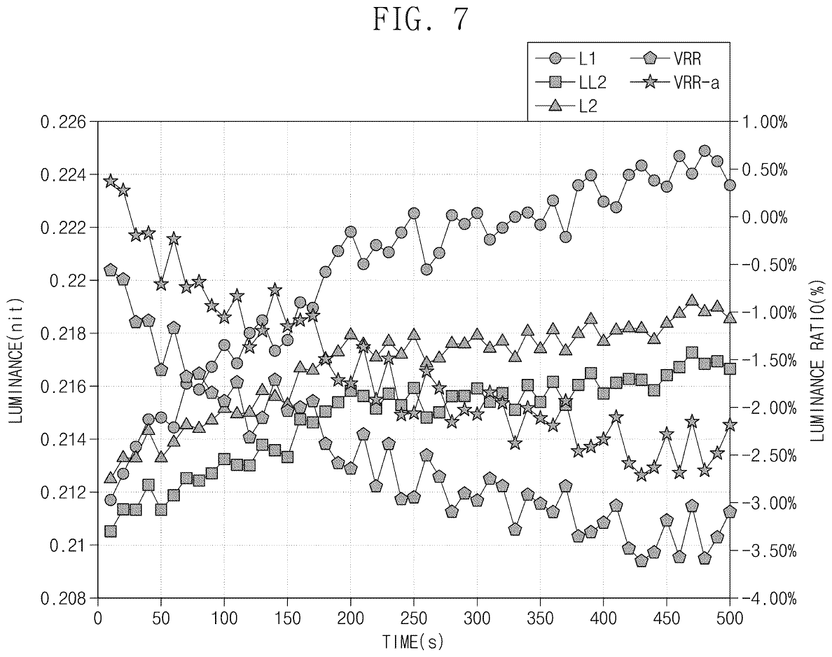

FIG. 7 is a graph showing a correlation between time, luminance and luminance ratio according to some embodiments of the present disclosure.

Referring to FIGS. 3, 5 and 7, a horizontal axis indicates time, a main vertical axis indicates luminance, and an auxiliary vertical axis indicates luminance ratio. A unit of the luminance may be nit, a unit of the luminance ratio may be %, and a unit of the time may be second. Graphs may indicate luminance or luminance ratio measured by aging the display panel DP according to time indicated on the horizontal axis.

A first luminance L1 is a value obtained by measuring a luminance of the display panel DP according to time, the luminance being corrected on the basis of the first frequency compensation luminance FCL1 and output at the first driving frequency F1. A second luminance L2 is a value obtained by measuring a luminance of the display panel DP according to time, the luminance being corrected on the basis of the second frequency compensation luminance FCL2 and output at the second driving frequency F2. A second comparative luminance LL2 is a value obtained by measuring a luminance of the display panel DP according to time, the luminance being output on the basis of the second frequency luminance FL2 at the second driving frequency F2. A comparative luminance ratio VRR may be defined as a value obtained by dividing a value obtained by subtracting the second comparative luminance LL2 from a first comparative luminance, which is output on the basis of the first frequency luminance FL1 at the first driving frequency F1, of the display panel DP by the first comparative luminance.

A luminance ratio VRR-a may be defined as a value obtained by dividing a value obtained by subtracting the second luminance L2 from the first luminance L1 by the first luminance L1.

Individual data of the first luminance L1, the second comparative luminance LL2, the second luminance L2, the comparative luminance ratio VRR, and the luminance ratio VRR-a are indicated by circular, quadrangular, triangular, pentagonal, and star-shaped markers, which are connected with lines, respectively.

The first luminance L1, the second comparative luminance LL2 and the second luminance L2 may be interpreted on the basis of the main vertical axis, and the comparative luminance ratio VRR and the luminance ratio VRR-a may be interpreted on the basis of the auxiliary vertical axis.

The second luminance L2 may be different from the second comparative luminance LL2 output using the second frequency luminance FCL2 due to the first offset R1. The second luminance L2 may be a value of luminance, which is corrected as the second frequency compensation luminance FL2 obtained by adding the first offset R1 to the second frequency luminance FL2 and output, of the display panel DP.

Accordingly, the second luminance L2 may have a shape of a graph in which the second comparative luminance LL2 is moved in parallel in a direction of a vertical axis.

The comparative luminance ratio VRR may be obtained by measuring an electronic device to which a luminance compensation method according to some embodiments of the present disclosure is not applied.

The luminance ratio VRR-a may be obtained by measuring the electronic device 10 (see FIG. 1) to which the luminance compensation method according to the present disclosure is applied.

For example, when comparing respective absolute values of the comparative luminance ratio VRR and the luminance ratio VRR-a with respect to the aged display panel DP, the value may be relatively improved from 3.5% to 2.5% (or about 3.5% to about 2.5%).

The first luminance L1 may be affected by the first frequency compensation luminance FCL1. The second luminance L2 may be affected by the second frequency compensation luminance FCL2. An absolute value of the luminance ratio VRR-a may be used for quality evaluation of the variable frequency mode. In a luminance compensation method of the electronic device 10 (see FIG. 1) according to some embodiments of the present disclosure, the display panel DP may be driven so that an absolute value of the luminance ratio VRR-a is within a range (e.g., a set or predetermined range). For example, the range (e.g., the predetermined range) may be 6% (or about 6%).

According to the present disclosure, an absolute value of the luminance ratio VRR-a may be smaller than that of the comparative luminance ratio VRR. When the display device DD operates in the variable frequency mode, luminance variation of the display panel DP between the high frequency and the low frequency may be relatively improved. Thus, the electronic device 10 (see FIG. 1) with relatively improved display quality and a luminance compensation method may be provided.

T1 bias is related to setting of a threshold voltage Vth of a driving transistor of each of the plurality of pixels PX. When a voltage is applied to the driving transistor, the voltage needs to be equal to or higher than a certain threshold voltage to allow current to flow in the driving transistor. T1 Bias may refer to a bias voltage which adjusts the threshold voltage and may change as time goes on. In particular, when a panel is used for a long time, the threshold voltage may change due to a field effect (charge trapping, hot carrier effect), and panel deterioration may occur.

Electroluminescent capacitor (EL Cap) serves to store charges to control emission of a light-emitting element of each of the plurality of pixels PX. When the pixel PX is driven, a capacitor may be repeatedly charged and discharged, and a luminance of the display panel DP may be determined. An initialization period may be changed as the driving frequency VIFF is changed. When the initialization period is long, stress of an element may be less accumulated, whereas when the initialization period is short, stress of an element may increase due to frequent charging and discharging of the capacitor. In addition, as time goes on, charge storage capability of the capacitor may be deteriorated, and panel deterioration may occur.

Unlike the present disclosure, the display panel DP may display an image at the first comparative luminance and the second comparative luminance LL2 by using the first frequency luminance FL1 and the second frequency luminance FL2 stored in the comparative lookup table. The first comparative luminance and the second comparative luminance LL2 may be similar to each other and a difference therebetween may not be significant at an early stage, but when the display panel DP is aged, panel deterioration may occur as time goes on due to variation in EL cap initialization period and T1 bias, and the luminance variation may occur. That is, the amount of change in luminance according to time at the low frequency may be smaller than the amount of change in luminance according to time at the high frequency due to the panel deterioration. Accordingly, luminance variation due to panel deterioration between the high frequency and the low frequency may occur. However, according to the present disclosure, the display panel DP may correct an image by using the second frequency compensation luminance FCL2 stored in the grayscale lookup table T1, and the display panel DP may be displayed at the second luminance L2. Thus, luminance variation due to panel deterioration between the high frequency and the low frequency of the display panel DP may be relatively improved. The electronic device 10 (see FIG. 1) with relatively improved display quality may be provided.

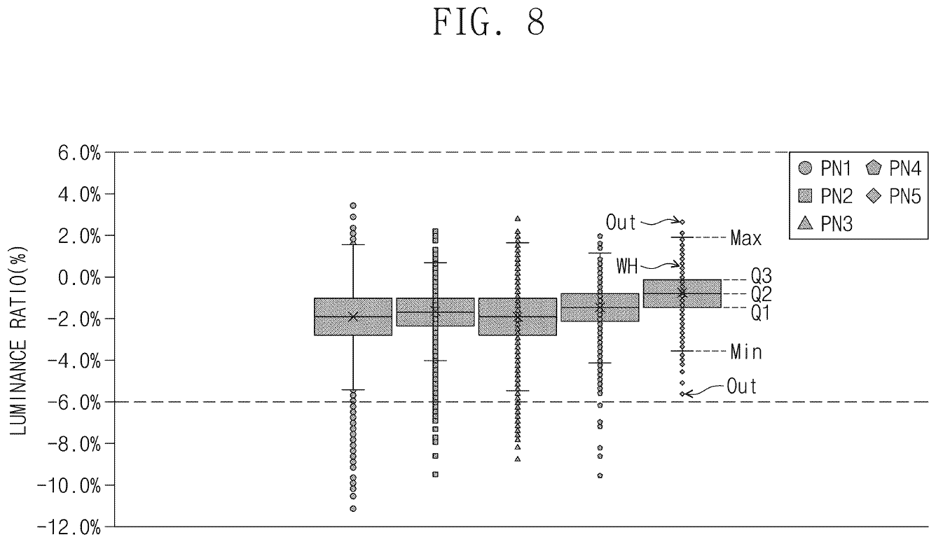

FIG. 8 is a graph showing luminance ratio for each display panel according to some embodiments of the present disclosure.

Referring to FIGS. 5, 7 and 8, box plot graphs are shown according to whether a luminance compensation method according to some embodiments of the present disclosure is applied or not. The graphs represent measurements of First Comparative Example PN1, Second Comparative Example PN2, Third Comparative Example PN3, Fourth Comparative Example PN4 and Example PN5. In this case, a vertical axis may refer to luminance ratio.

First Comparative Example PN1, Second Comparative Example PN2, Third Comparative Example PN3 and Fourth Comparative Example PN4 each show luminance ratio obtained by measuring an electronic device to which the luminance compensation method according to some embodiments of the present disclosure is not applied.

Example PN5 shows luminance ratio obtained by measuring the electronic device 10 (see FIG. 1) to which the luminance compensation method according to some embodiments of the present disclosure is applied. Example PN5 may have the luminance ratio VRR-a.

A box plot may include a Spear style and a Tukey style. The box plot is a data visualization type, which shows distribution and an outlier of data at the same time, thereby making it possible to easily compare data groups different from each other, and may process and visualize data with a statistical concept which is five-number summary. The five-number summary is a method in which data is represented using five kinds of statistics and may include a minimum value Min, a maximum value Max, a first quartile Q1, a second quartile Q2 (a median) and a third quartile Q3.

In the box plot, 50% (or about 50%) of data is distributed above a second quartile, and the remaining 50% (or about 50%) is distributed below the second quartile. Each piece of data is indicated by a dot having a shape. Data of First Comparative Example PN1 is indicated in a circular shape, data of Second Comparative Example PN2 is indicated in a quadrangular shape, data of Third Comparative Example PN3 is indicated in a triangular shape, data of Fourth Comparative Example PN4 is indicated in a pentagonal shape, and data of Example PN5 is indicated in a rhombic shape.

A line connected to both ends of a box is referred to as a whisker WH. The top of the whisker WH is referred to as the maximum value Max, the bottom of the whisker WH is referred to as the minimum value Min, and data indicated by a dot outside this line is considered as an outlier which exhibits unusual distribution and is referred to as an outlier Out. From the outlier Out at a lowermost end to the outlier Out at an uppermost end may be considered as a range of data.

Unlike embodiments according to the present disclosure, absolute values of luminance ratio measured in First Comparative Example PN1 to Fourth Comparative Example PN4 may not be defined within a range (e.g., a set or predetermined range). The outliers Out of luminance ratio measured in First Comparative Example PN1 to Fourth Comparative Example PN4 may be out of range. For example, the range (e.g., the set or predetermined range) may be −6% (or about −6%) to 6% (or about 6%). A luminance ratio of one of First Comparative Example PN1 to Fourth Comparative Example PN4 may be the comparative luminance ratio VRR. However, according to some embodiments of the present disclosure, the luminance ratio VRR-a measured in Example PN5 may be defined within the range (e.g., the set or predetermined range). The outlier Out of the luminance ratio VRR-a may not be out of range. An absolute value of the luminance ratio VRR-a may be smaller than an absolute value of the comparative luminance ratio VRR. When the display device DD operates in the variable frequency mode, luminance variation of the display panel DP may be relatively improved. Thus, the electronic device 10 (see FIG. 1) with relatively improved display quality and a luminance compensation method may be provided.

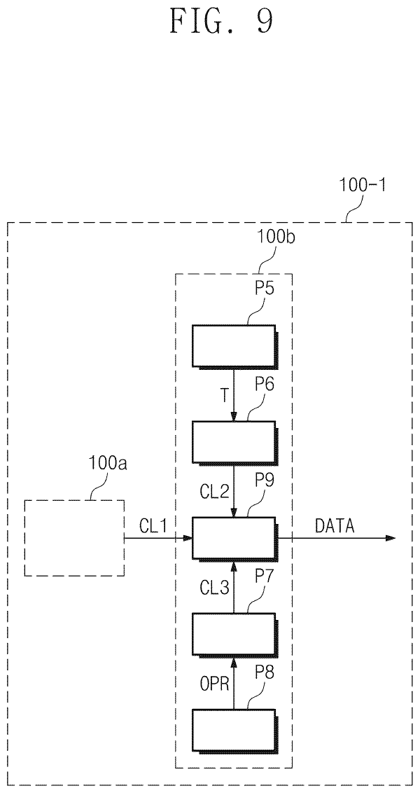

FIG. 9 is a block diagram illustrating a driving controller according to some embodiments of the present disclosure. In describing with reference to FIG. 9, components described with reference to FIG. 5 are denoted as the same reference numerals or symbols, and some descriptions thereof may be omitted.

Referring to FIGS. 1, 3, 5 and 9, a driving controller 100-1 may include the first driving part 100a (see FIG. 5). In addition, the driving controller 100-1 may further include a temperature output part (or temperature output component or temperature output circuit or temperature outputter) P5, a second luminance compensation part (or second luminance compensator or second luminance compensation component or second luminance compensation circuit) P6, a ratio output part (or ratio outputter or ratio output circuit or ratio output component) P8, a third luminance compensation part (or third luminance compensator or third luminance compensation component or third luminance compensation circuit) P7, and an image output part (or image outputter or image output component or image output circuit) P9. For example, the temperature output part P5, the second luminance compensation part P6, the ratio output part P8, the third luminance compensation part P7, and the image output part P9 may be referred to as a second driving part 100b.

The temperature output part P5 may output temperature T of the display panel DP.

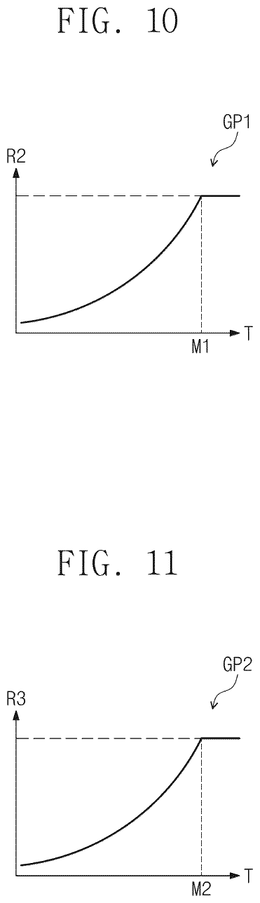

The second luminance compensation part P6 may output a second compensation luminance CL2 by using a second offset R2 (see FIG. 10) calculated on the basis of the temperature T of the temperature output part P5. This will be described later with reference to FIG. 10.

The ratio output part P8 may output an effective pixel ratio OPR of the display panel DP. The effective pixel ratio OPR may be a ratio of turned-on pixels to the plurality of pixels PX. This will be described in more detail later with reference to FIG. 11.

The third luminance compensation part P7 may output a third compensation luminance CL3 by using a third offset R3 (see FIG. 11) calculated on the basis of the effective pixel ratio OPR of the ratio output part P8.

The image output part P9 may control the display panel DP to display an image on the basis of the first compensation luminance CL1, the second compensation luminance CL2 and the third compensation luminance CL3. An image data signal DATA may be output in consideration of the first compensation luminance CL1, the second compensation luminance CL2 and the third compensation luminance CL3, and the plurality of pixels PX may output an image on the basis of the image data signal DATA. That is, the driving controller 100-1 may compensate luminance variation in consideration of the effective pixel ratio OPR and the temperature T according to panel deterioration. Thus, the electronic device 10 with relatively improved display quality may be provided.

FIG. 10 is a graph showing second offset versus temperature according to some embodiments of the present disclosure.

Referring to FIGS. 9 and 10, a horizontal axis indicates temperature of the display panel DP (see FIG. 3). A vertical axis indicates the second offset R2 that is added when the second compensation luminance CL2 is output.

A first graph GP1 may be stored in the second luminance compensation part P6. The second luminance compensation part P6 may select the second offset R2 corresponding to the temperature T which is received from the temperature output part P5 by using the first graph GP1. The second luminance compensation part P6 may output the second compensation luminance CL2 by using the second offset R2.

The second offset R2 may be proportional to the temperature T. For example, as the temperature T of the display panel DP (see FIG. 3) increases, the second offset R2 may increase, and as the temperature T decreases, the second offset R2 may decrease.

The second offset R2 may have the same value (or a constant value) when the temperature T is equal to or higher than a first value (e.g., a set or predetermined first value) M1.

Unlike embodiments according to the present disclosure, when the temperature T does not have a maximum value (e.g., a set or predetermined maximum value), compensation due to the second offset exceeding the maximum value may occur. Accordingly, reversal of luminance ratio may occur. However, according to some embodiments of the present disclosure, the temperature T may have a maximum value (e.g., a set or predetermined maximum value) in the first graph GP1. Reversal of the luminance ratio VRR-a may be prevented, reduced, or removed. Thus, a luminance compensation method with relatively improved reliability may be provided.

FIG. 11 is a graph showing second offset versus effective pixel ratio according to some embodiments of the present disclosure.

Referring to FIGS. 9 and 11, a horizontal axis indicates the effective pixel ratio OPR of the display panel DP (see FIG. 3). A vertical axis indicates the third offset R3 added when the third compensation luminance CL3 is output.

A second graph GP2 may be stored in the third luminance compensation part P7. The third luminance compensation part P7 may select the third offset R3 corresponding to the effective pixel ratio OPR which is received from the ratio output part P8 by using the second graph GP2. The third luminance compensation part P7 may output the third compensation luminance CL3 by using the third offset R3.

The third offset R3 may be proportional to the effective pixel ratio OPR. For example, as the effective pixel ratio OPR increases, the third offset R3 may increase, and as the effective pixel ratio OPR decreases, the third offset R3 may decrease.

The third offset R3 may have the same value (or a constant value) when the effective pixel ratio OPR is equal to or higher than a second value (e.g., a set or predetermined second value) M2.

Unlike embodiments according to the present disclosure, when the effective pixel ratio OPR does not have a maximum value (e.g., a set or predetermined maximum value), compensation due to the third offset exceeding the maximum value may occur. Accordingly, reversal of luminance ratio may occur. However, according to some embodiments of the present disclosure, the effective pixel ratio OPR may have a maximum value (e.g., a set or predetermined maximum value) in the second graph GP2. Reversal of the luminance ratio VRR-a may be prevented, reduced, or removed. Thus, a luminance compensation method with relatively improved reliability may be provided.

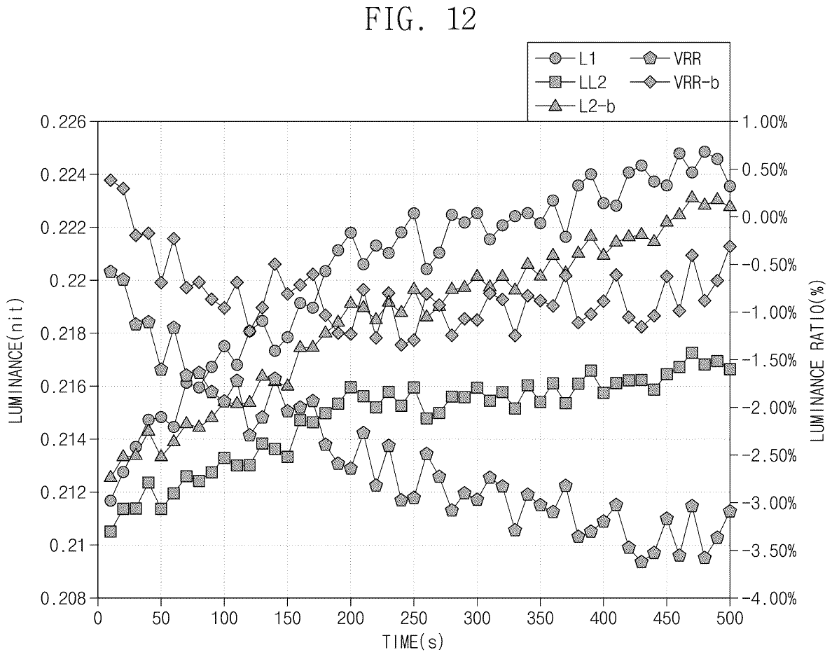

FIG. 12 is a graph showing a correlation between compensation luminance and luminance ratio according to some embodiments of the present disclosure. In describing with reference to FIG. 12, components described with reference to FIG. 7 are denoted as the same reference numerals or symbols, and some descriptions thereof may be omitted.

Referring to FIGS. 3, 9 and 12, a second luminance L2-b is a value obtained by measuring a luminance, which is output on the basis of the first compensation luminance CL1, the second compensation luminance CL2 and the third compensation luminance CL3 at the second driving frequency F2, of the display panel DP.

A luminance ratio VRR-b may be defined as a value obtained by dividing a value obtained by subtracting the second luminance L2-b from a first luminance L1 by the first luminance L1. Individual data of the second luminance L2-b is indicated by triangular markers, which are connected with a line.

The second luminance L2-b may be different from a second comparative luminance LL2 output using the second frequency luminance FL2. The second luminance L2-b may be a value of luminance, which is corrected as a value obtained by adding the second offset R2 and the third offset R3 to the second frequency compensation luminance FCL2 and output, of the display panel DP.

The luminance ratio VRR-b may be obtained by measuring the electronic device 10 (see FIG. 1) to which a luminance compensation method using the driving controller 100-1 according to some embodiments of the present disclosure is applied.

An absolute value of the luminance ratio VRR-b may be used for quality evaluation of the variable frequency mode. In a luminance compensation method of the electronic device 10 (see FIG. 1) according to some embodiments of the present disclosure, the display panel DP may be driven so that an absolute value of the luminance ratio VRR-b is within a range (e.g., a set or predetermined range). For example, the range (e.g., the set or predetermined range) may be 1.5% (or about 1.5%).

According to some embodiments of the present disclosure, the driving controller 100-1 may compensate luminance variation in consideration of the effective pixel ratio OPR and the temperature T according to panel deterioration. The plurality of pixels PX may output an image on the basis of the image data signal DATA output by the driving controller 100-1. In this case, when the luminance ratio VRR-b and a comparative luminance ratio VRR are measured, an absolute value of the luminance ratio VRR-b may be smaller than that of the comparative luminance ratio VRR. When the display device DD operates in the variable frequency mode, luminance variation of the display panel DP between the high frequency and the low frequency may be relatively improved. Thus, the electronic device 10 (see FIG. 1) with relatively improved display quality and a luminance compensation method may be provided.

According to the descriptions above, a driving controller may correct variation in the amount of luminance by using a grayscale lookup table. A display panel may be controlled to display an image on the basis of a first compensation luminance stored in the grayscale lookup table. An image data signal may be output in consideration of the first compensation luminance, and a plurality of pixels may output an image on the basis of the image data signal.

Also for the case of panel deterioration according to temperature and an effective pixel, the display panel may be controlled to display an image on the basis of second and third compensation luminance stored in the grayscale lookup table. Thus, an electronic device with relatively improved display quality may be provided.

In addition, according to the descriptions above, temperature and effective pixel ratio in a second graph may each have a maximum value (e.g., a set or predetermined maximum value). Reversal of luminance ratio may be prevented, reduced, or removed. Thus, a luminance compensation method with relatively improved reliability may be provided.

In the above, description has been made with reference to aspects of some embodiments of the present disclosure, but those skilled or of ordinary skill in the art may understand that various modifications and changes may be made to the embodiments according to the present disclosure insofar as such modifications and changes do not depart from the spirit and technical scope of embodiments according to the present disclosure as set forth in the claims, and their equivalents, to be described later.

Therefore, the technical scope of embodiments according to the present disclosure is not to be limited to the contents stated in the detailed description of the specification, but should be determined by the appended claims, and their equivalents.

What is claimed is:

1. A display device comprising:
a display panel including a plurality of pixels and configured to display an image; and
a driving controller configured to drive the display panel,
wherein the driving controller includes
a memory in which a grayscale lookup table is stored,
a frequency determiner configured to determine a driving frequency of the display panel,
a luminance determiner configured to determine a target luminance and a target grayscale of the image, and
a first luminance compensator configured to output a first compensation luminance based on the grayscale lookup table, the driving frequency, the target luminance, and the target grayscale,
wherein the driving controller is configured to control the display panel to display the image based on the first compensation luminance,
the driving frequency includes a first driving frequency and a second driving frequency having a lower frequency than the first driving frequency,
the first compensation luminance includes a first frequency compensation luminance output at the first driving frequency and a second frequency compensation luminance output at the second driving frequency, and
the second frequency compensation luminance is higher than the first frequency compensation luminance.

2. The display device of claim 1, wherein, in the grayscale lookup table, the first compensation luminance by grayscale, measured using multi-time programming (MTP), is stored,
the first frequency compensation luminance output at the first driving frequency and the second frequency compensation luminance output at the second driving frequency are stored as the first compensation luminance, and
a value obtained by adding a first offset to a luminance corresponding to a portion of grayscale of the first frequency compensation luminance is stored as the second frequency compensation luminance.

3. The display device of claim 1, wherein a luminance ratio is a value obtained by dividing a value obtained by subtracting a second luminance of the display panel driven at the first driving frequency from a first luminance of the display panel driven at the second driving frequency by the first luminance, and an absolute value of the luminance ratio is equal to or lower than 6%.

4. The display device of claim 2, wherein the second frequency compensation luminance is a value obtained by adding the first offset to the first frequency compensation luminance.

5. The display device of claim 1, wherein the driving controller further comprises:
a temperature output part configured to output a temperature of the display panel; and
a second luminance compensator configured to add a second offset calculated based on the temperature to the second frequency compensation luminance and to output a second compensation luminance.

6. The display device of claim 5, wherein the second offset is proportional to the temperature.

7. The display device of claim 5, wherein the second offset has a constant value based on the temperature being equal to or higher than a predetermined first value.

8. The display device of claim 5, wherein the driving controller further comprises:
a ratio output part configured to output an effective pixel ratio of the display panel; and
a third luminance compensator configured to add a third offset calculated based on the effective pixel ratio to the second compensation luminance and to output a third compensation luminance.

9. The display device of claim 8, wherein the driving controller is configured to control the display panel to display the image based on the first compensation luminance, the second compensation luminance, and the third compensation luminance.

10. The display device of claim 8, wherein the effective pixel ratio is a ratio of turned-on pixels to the plurality of pixels, and the third offset is proportional to the effective pixel ratio.

11. The display device of claim 8, wherein the third offset has a constant value based on the effective pixel ratio being equal to or higher than a predetermined second value.

12. A display device luminance compensation method, for compensating luminance of a display device comprising a display panel including a plurality of pixels and configured to display an image and a driving controller configured to drive the display panel and receive an image signal, comprising:
generating a grayscale lookup table in which compensation luminance according to grayscale is stored by using multi-time programming (MTP);
outputting a driving frequency of the display panel;
outputting a target luminance and a target grayscale of the image based on the image signal;
outputting a first compensation luminance based on the driving frequency, the target luminance, the target grayscale, and the grayscale lookup table; and
displaying the image based on the first compensation luminance,
wherein the driving frequency includes a first driving frequency and a second driving frequency having a lower frequency than the first driving frequency,
the first compensation luminance includes a first frequency compensation luminance output at the first driving frequency and a second frequency compensation luminance output at the second driving frequency, and
the second frequency compensation luminance is higher than the first frequency compensation luminance.

13. The display device luminance compensation method of claim 12, wherein a value obtained by adding a first offset to a luminance corresponding to a portion of grayscale is stored in the grayscale lookup table at the second driving frequency compared to the grayscale lookup table at the first driving frequency.

14. The display device luminance compensation method of claim 12, wherein a luminance ratio is a value obtained by dividing a value obtained by subtracting a second luminance of the display panel driven at the first driving frequency from a first luminance of the display panel driven at the second driving frequency by the first luminance, and an absolute value of the luminance ratio is equal to or lower than 6%.

15. The display device luminance compensation method of claim 13, wherein the second frequency compensation luminance is a value obtained by adding the first offset to the first frequency compensation luminance.

16. The display device luminance compensation method of claim 12, comprising outputting a second compensation luminance which is obtained by adding a second offset calculated based on a temperature of the display panel to the second frequency compensation luminance.

17. The display device luminance compensation method of claim 16, wherein the second offset is proportional to the temperature, and the second offset has a constant value based on the temperature being equal to or higher than a predetermined first value.

18. The display device luminance compensation method of claim 16, further comprising outputting a third compensation luminance obtained by adding a third offset calculated based on an effective pixel ratio to the second compensation luminance.

19. The display device luminance compensation method of claim 18, wherein the displaying of the image based on the first compensation luminance comprises generating image data based on the second compensation luminance and the third compensation luminance.

20. An electronic device comprising:
a display panel including a plurality of pixels and configured to display an image;
a driving controller configured to drive the display panel; and
a processor configured to drive the driving controller,
wherein the driving controller includes:
a memory in which a grayscale lookup table is stored;
a frequency determiner configured to determine a driving frequency of the display panel;
a luminance determiner configured to determine a target luminance and a target grayscale of the image; and
a first luminance compensator configured to output a first compensation luminance based on the grayscale lookup table, the driving frequency, the target luminance, and the grayscale,
wherein the driving controller is configured to control the display panel to display the image based on the first compensation luminance,
the driving frequency includes a first driving frequency and a second driving frequency having a lower frequency than the first driving frequency,
the first compensation luminance includes a first frequency compensation luminance output at the first driving frequency and a second frequency compensation luminance output at the second driving frequency, and
the second frequency compensation luminance is higher than the first frequency compensation luminance.
